(19) United States
(12) Patent Application Publication
(10) Pub. No.: US 2009/0310865 A1
(43) Pub. Date: Dec. 17, 2009

(54) Video Surveillance System, Annotation And De-Annotation Modules Thereof

(76) Inventors: Jenn Hwan Tarng, Hsinchu (TW); Jwu-Sheng Hu, Hsinchu (TW); Yu Lun Huang, Hsinchu (TW); Bor-Gaung Chang, Taoyuan (TW); Chie-Chung Kuo, Keelung (TW); Lih-Guong Jang, Hsinchu (TW); Li-Huei Chen, Hsinchu (TW)

Correspondence Address: LIN & ASSOCIATES INTELLECTUAL PROPERTY, INC., P.O. BOX 2339, SARATOGA, CA, 95070-0339, US

(21) Appl. No.: 12/344,232

(22) Filed: Dec. 25, 2008

(30) Foreign Application Priority Data
Jun. 13, 2008 (TW) 097122273

(51) Int. Cl. G06K 9/46; H04N 7/18

(52) U.S. Cl. 382/190; 348/143

(57) ABSTRACT

A video surveillance system gets a first image from at least a video source, and extracts its image features. It embeds annotation information with at least the image features into the first image, and converts the embedded image into a second image without changing the image format. After having compressed and decompressed the second image, the system extracts the embedded information from the decompressed embedded stream to separate the image and the annotation information, thereby obtaining completely recovered annotation information after a recovery process and an image processing. Because the image format is not changed, the operations on the second image at the rear end of the system, such as compression and decompression, are not affected.

### FIELD OF THE INVENTION

The present invention generally relates to a video surveillance system and video information annotation and de-annotation technologies thereof.

### BACKGROUND OF THE INVENTION

The early video surveillance system uses analogue monitors with video cassette recorder (VCR), and manually finds and reviews the proper recorded tape after a certain event occurred. The current video surveillance system, on the other hand, is digitized. The IP camera is used as a monitor, and surveillance video images are transformed into digital information and transmitted through the network to the system back-end. The system back-end replaces the tape-based VCR with the digital video recorder (DVR) for accelerating information search and having more convenient data storage. Because of the digitization on image extraction and image storage, the application of security surveillance is widely promoted. However, in the event processing, only time index is used for manual elevation after an event occurred. If the image content can be identified and analyzed during the image extraction process, and the image information can be integrated with the information of the external sensor and annotated in the image content, the subsequent processing and search may be based on time index, event, image content, or personage. Furthermore, the system may directly determine the occurrence of events, issue warning messages, automatically record the images and execute subsequent processing.

U.S. Pat. No. 6,928,165 disclosed a communication system using a multiplexer and time division or frequency division schemas to transmit image and add-on information respectively through a transmission interface, and adding digital watermark in the image to describe the relation between image and the add-on information. However, the image and the add-on information are not integrated into a format identical to the original image for transmission. Therefore, an additional synchronization mechanism is required for the add-on information and the image.

U.S. Pat. No. 6,952,236 disclosed a technique of conversion of text embedded in a video stream by hiding the information in the time duration of a line break for the scanning lines. After the information is extracted, a converter converts the text data format to a format matching with the European or American system. Such text embedded architecture may be applicable to the scanning display systems. After the data compression, the hidden information no longer exists; therefore, the technique is not applicable to the current video surveillance systems based on IP Cam, and the like.

U.S. Pat. No. 7,050,604 disclosed related methods by using watermark to embed the object specific information into video. After transmission, the video information embedded with watermark is decoded to obtain the separate video information and object information. The document describes neither the image compression and decompression process nor how to guarantee the data integrity of the obtained object information.

Among the aforementioned and current security surveillance systems, some systems only include image extraction capability at the front-end, and transmit the additional information to the back-end for processing. In this manner, the image and the data are transmitted separately. Therefore, it requires additional data transmission interface, and the data and the image must be synchronized. Thus, the system complexity increases. Some systems annotate the text information onto the image directly, such as system time, location. This type of annotation information is fixed, and the format of the annotated image has been changed or it may not be recovered as the original image.

### SUMMARY OF THE INVENTION

In an exemplary embodiment, the disclosed is directed to a video surveillance system, comprising an image feature extraction module, an image information annotation module, an image compression module, an image decompression module, and an image information de-annotation module. The image feature extraction module captures at least an image as the original image, and extracts the feature information of the original image. The image information annotation module embeds the annotation information including at least the feature information to the original image, and converts the embedded image into the same format as the original image. The annotated image is compressed by the image compression module. The image decompression module decompresses the compressed image, and image information de-annotation module extracts embedded information from the decompressed embedded stream. After the error recovery decoding and image processing, the object image and annotation information are separated.

In another exemplary embodiment, the disclosed is directed to an image information annotation module, comprising an error recovery processing unit, an image processing unit, and an annotation unit. The error recovery processing unit encodes the annotation information into embedded information through an error recovery encoding method and a threshold computation. The image processing unit processes the original image to compute the capacity for the embedded information. The annotation unit embeds the L encoded embedded information into the original image, where L is a multiple of the embeddable information. The embedded image is converted into another image of the same format as the original image.

In another exemplary embodiment, the disclosed is directed to an image information de-annotation module, comprising a de-annotation unit and an image processing unit. The de-annotation unit extracts the embedded information from the embedded stream, and obtains de-annotation information through error recovery processing. The de-annotation information is the intact recovery of the annotation information. The image processing unit may separate the image and the de-annotation information.

Yet in another exemplary embodiment, the disclosed is directed to a video annotation method, comprising: embedding annotated information including at least the feature information of an original image to the original image; and converting the embedded image into the same format as the original image.

Yet in another exemplary embodiment, the disclosed is directed to a video de-annotation method, comprising: extracting embedded information from an embedded stream; obtaining de-annotation information from the extracted embedded information where the de-annotation information being the intact recovery of the annotation information; and obtaining video information and environmental parameter information of an object image through image processing.

The foregoing and other features, aspects and advantages of the present invention will become better understood from a careful reading of a detailed description provided herein below with appropriate reference to the accompanying drawings.

### BRIEF DESCRIPTION OF THE DRAWINGS

FIG. 1 shows an exemplary video surveillance system, consistent with certain disclosed embodiments of the present invention.

FIG. 2 shows an exemplary image information annotation module, consistent with certain disclosed embodiments of the present invention.

FIG. 3 shows an exemplary flowchart illustrating an image information annotation method, consistent with certain disclosed embodiments of the present invention.

FIG. 4 shows an exemplary image information de-annotation module, consistent with certain disclosed embodiments of the present invention.

FIG. 5 shows an exemplary flowchart illustrating an image information annotation method, consistent with certain disclosed embodiments of the present invention.

FIG. 6 shows a working example to describe the annotation and de-annotation technique for video information, and a video surveillance system of embedding the video information into a video stream, consistent with certain disclosed embodiments of the present invention.

### DETAILED DESCRIPTION OF THE PREFERRED EMBODIMENTS

The present disclosed embodiments may provide a technique for video annotation and de-annotation, and a video surveillance system for embedding information in the video stream. The video annotation technique adds the additional information, such as image feature information and annotation information from the external sensed signal, to the original image, and converts to an image of the same format as the original image. The video de-annotation technique may cooperate with the current image processing technique to recover from the annotated image to the original image and guarantee the integrity of the annotation information.

According to the exemplary embodiments disclosed in the present invention, the video information annotation technique is to add the additional information into the original image and converts the embedded image into the same format as the original image for subsequent processing of video surveillance systems. The additional information may be object features, movement or relation from the original image, the environmental parameters obtained from the external sensor, and so on. Because the video format is not changed, the subsequent processes, such as compression, transmission, decompression and storage, will not be affected. The video information de-annotation technique utilizes the matched de-annotation and decoding techniques of the system front-end to obtain the annotation information from the image, and utilizes the error recovery encoding technique and threshold scheme to perform fast recovery and guarantee the integrity of the de-annotated annotation information.

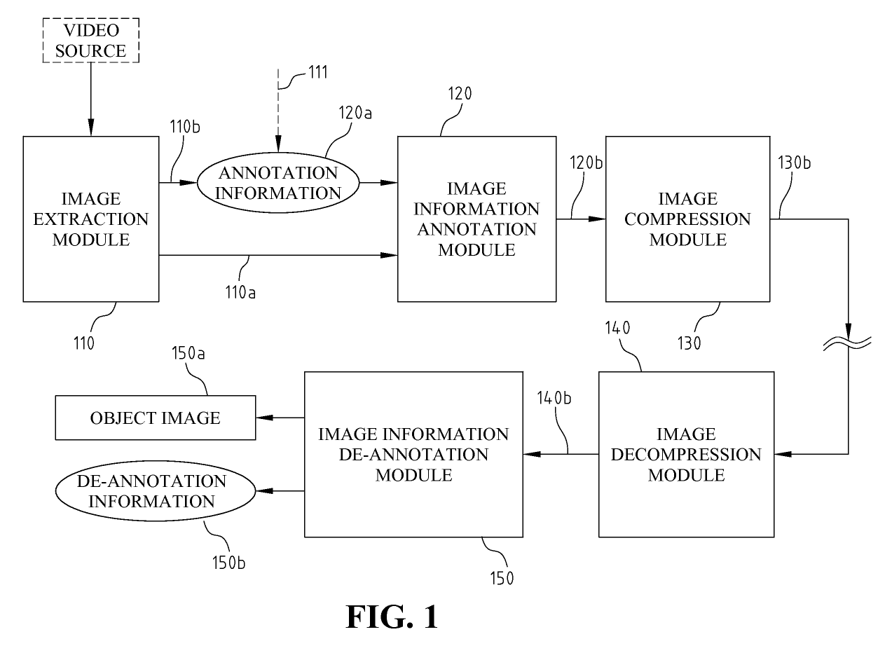

FIG. 1 shows an exemplary video surveillance system, consistent with certain disclosed embodiments of the present invention. Referring to FIG. 1, a video surveillance system 100 may comprise an image extraction module 110, an image information annotation module 120, an image compression module 130, an image decompression module 140, an image information de-annotation module 150, and an image display module 160. Through image information annotation module 120, video surveillance system 100 may embed information into the video stream. Through image information de-annotation module 150, video surveillance system 100 may extract the original embedded information.

Image extraction module 110 captures at least a video source to obtain an original image 110a and extracts feature information 110b of original image 110a, such as the location of moving object, whether human intrusion or not, or the feature parameters of the intruding person, and so on. The data amount of feature information 110b is far less than the data amount of original image 110a. The extraction may be accomplished by image processing or recognition and identification schemas. Image information annotation module 120 embeds annotation information 120a into original image 110a. Annotation information 120a includes at least feature information 110b. For example, annotation information 120a may include feature information 110b and environmental parameter information 111. Image information annotation module 120 converts the embedded image into another image of the same format as original image 110a, i.e., embedded image 120b. Because the image format is not changed, embedded image 120b may be compressed by image compression module 130, or streamed to remote site or storage devices.

To obtain the original information, image decompression module 140 may decompress compressed image 130b, and image information de-annotation module 150 may extract the embedded information from decompressed embedded stream 140b. After error recovery decoding and image processing on the extracted embedded information, object image 150a and obtained de-annotation information 150b are separated.

For video surveillance system 100, environmental parameter information 111 refers to the information of the externally sensed signals, such as from the external sensors, CO, CO2 detectors, humidity/temperature meter, photo-sensor, radio frequency identification (RFID), timer, flow meter, and so on, to obtain the information of the externally sensed signals. The information may be time, temperature, humidity, or other data. The data amount is far less than the data amount of the original image.

Environment parameter information 111 and feature information 110b may be combined and encoded to become encoded embedded information. The encoding techniques may be error recovery encoding technique, such as Hamming code, BCH Code, Reed-Solomon Code, Reed-Muller Code, Convolutional Code, Turbo Code, Low Density Parity Check (LDPC) Code, Repeat-Accumulate (RA) Code, Space Time Code, Factor Graphs, Soft-decision Decoding, Guruswami-Sudan Decoding, Extrinsic Information Transfer Chart (EXIT Chart), Iterative Decoding, and so on. The encoded embedded information may be embedded in the image stored in the video buffer to become another image with annotation information. The embedding technique may be Non-destructive Electronic Watermark, On Screen Display (OSD) or covered in a specific image area.

The length |i| of the embedded information may be obtained through the above encoding techniques. Based on the original image, through visually Non-destructive method, it is able to estimate the embeddable information capacity |C| that the intact information may be guaranteed after embedding the information in the image and compressing the embedded image. First, the network status n at that time is computed, including network latency, loss rate, and so on. Also, the compression ratio R of the compression module is computed. The threshold scheme is used to compute an embedded information multiple L, where L=f(|C|, |i|, n, R). In other words, multiple L depends on embeddable information capacity |C|, embedded information length |i|, network status n and compression ratio R. L copies of the embedded information are embedded into the image, and then the intact embedded information may be recovered after decompression. It may ensure the data amount L*|i| is less than capacity |C| through the following exemplary schemas. That is, by reducing the important information or items of sensed information, which is a part of the application technical specification, or performing data division and embedding in a series of continuous images.

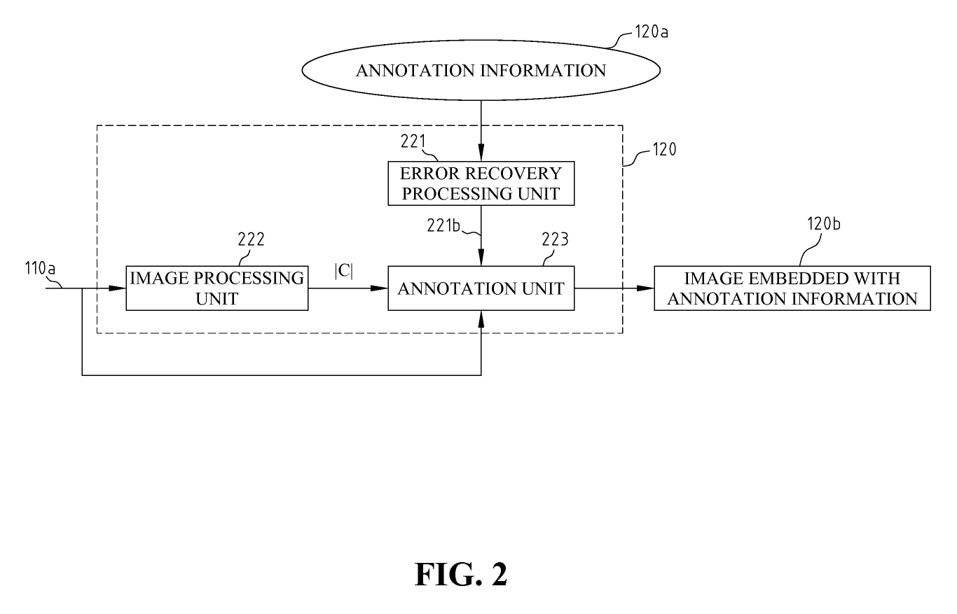

FIG. 2 shows an exemplary image information annotation module, consistent with certain disclosed embodiments of the present invention. Referring to FIG. 2, image information annotation module 120 may comprise an error recovery processing unit 221, an image processing unit 222 and an annotation unit 223. Error recovery processing unit 221 encodes annotation information 120a into embedded information 221b through an error recovery encoding method and a threshold scheme. Image processing unit 222 processes original image 110a obtained from image feature extraction module 110 and compute embeddable information capacity |C| in original image 110a. Annotation unit 223 embeds L copies of the embedded information into original image 110a, and converts the image with embedded information into an embedded image 120b of the same format as original image 110a, such as YUV, RGB, YCbCr, NTSC, PAL, and so on.

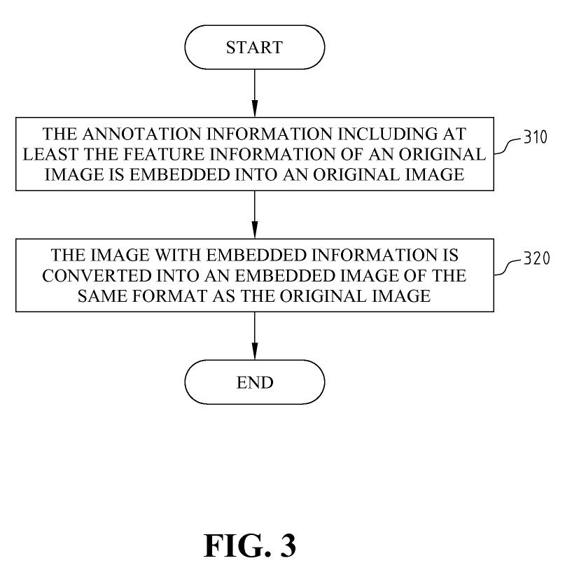

FIG. 3 shows an exemplary flowchart illustrating a video information annotation method, consistent with certain disclosed embodiments of the present invention. Referring to FIG. 3, the annotation information including at least the feature information of an original image is embedded into an original image, as shown in step 310. In this step, the feature information of the original image may be combined with the environmental parameter information into the annotation information, and encoded as embedded information. L copies of the embedded information are then embedded into the original image. In step 320, the image with embedded information is converted into an embedded image of the same format as the original image.

Because the image format is not changed by the annotation information, the compression module may compress the embedded image directly and stream to remote sites or storage devices. For example, the annotated image may be compressed as Motion JPEG or Mpeg-4 format, and transmitted through network or specific transmission path to the system back-end.

In real-time video surveillance systems, such as real-time playback, analysis, warning, etc., security surveillance system, in order to obtain the original information, the system back-end may decompress the compressed image. After decompression, the image may be restored to the original format, such as YUV, RGB, YCbCr, NTSC, PAL, and so on. After the compression-and-decompression process, the video information is not the same as the video information before the compression. The system may input index parameter to fast search for video information containing index parameters, and extract the original embedded information through de-annotation techniques matching the system front-end, such as electronic watermark. Through error recovery decoding techniques matching the system front-end, the annotated image feature parameters and environmental parameters may be obtained from the image.

If in non-real-time system, the system back-end may store the information in the database after obtaining Motion JPEG or Mpeg-4 format information. When an index search is requested later, the decompression and de-annotation techniques are used to compare against the object video information. Alternatively, after the system back-end decompresses the image files, the image files such as YUV, RGB, YCbCr, NTSC or PAL formats may be stored in the database. When an index search is requested later, the image of the original format embedded with image feature parameters and environmental parameters may be directly compared to obtain the target image information.

The aforementioned error recovery encoding technique and threshold scheme may compute the amount of backup information. The accurate embedding capacity computation and the error recovery may ensure the integrity of the de-annotated image feature parameters and the environmental parameters as well as the correctness of the index search parameters.

The significant difference between the present invention and the conventional electronic watermark technique is that the watermark technique is mainly for copyright identification, and only requires 70% identification rate to be effective. However, the embedded information according to the present invention is 100% recovered. Therefore, the present invention may make the de-annotation information extracted by system back-end same as the annotation information of the system front-end through error recovery processing.

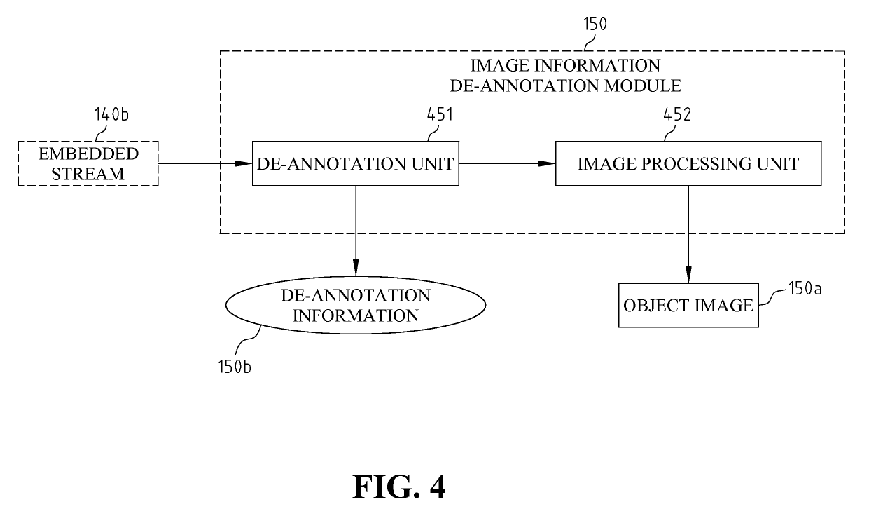

FIG. 4 shows an exemplary image information de-annotation module, consistent with certain disclosed embodiments of the present invention. Referring to FIG. 4, image information de-annotation module 150 mainly includes a de-annotation unit 451 and an image processing unit 452. De-annotation unit 451 extracts embedded information from an embedded stream, and obtains de-annotation information 150b through error recovery processing. Image processing unit 452 separates an object image from de-annotation information 150b. The de-annotation information is the fully recovered annotation information. When applied to video surveillance system 100, the embedded stream with the embedded information is the decompressed embedded stream 140b. Because de-annotation information 150b is the fully recovered annotation information, de-annotation information 150b is feature information 110b of the original image and environmental parameter information 111, and the separated object image is object image 150a.

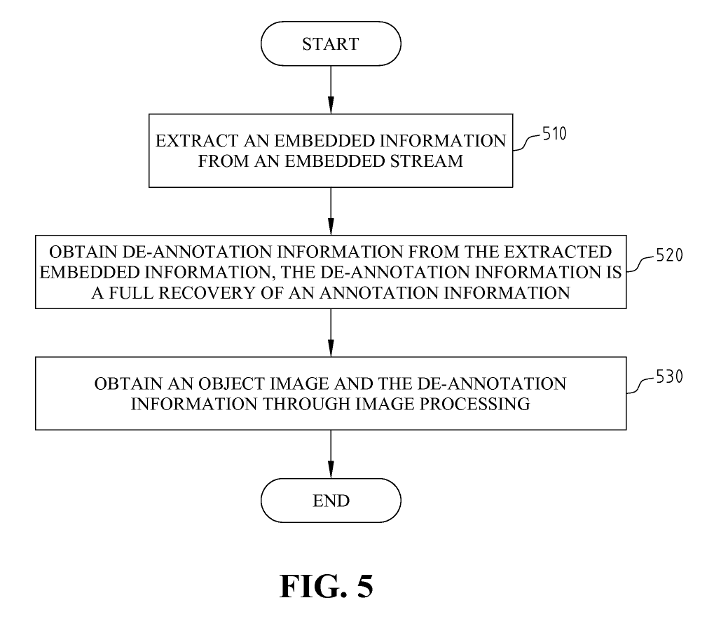

FIG. 5 shows an exemplary flowchart illustrating an image de-annotation method, consistent with certain disclosed embodiments of the present invention. Referring to FIG. 5, embedded information is extracted from an embedded stream, as shown in step 510. In step 520, de-annotation information is obtained from the extracted embedded information, where the de-annotation information is the fully recovered annotation information. In step 530, an object image and the de-annotation information are obtained through image processing.

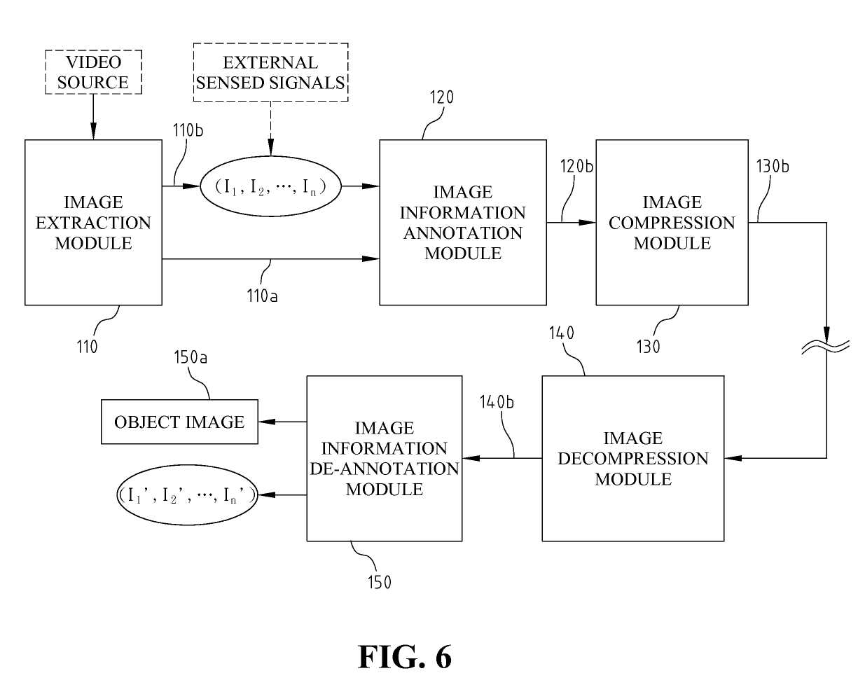

FIG. 6 shows a working example to describe the annotation and de-annotation technique for video information, and a video surveillance system of embedding the video information into a video stream, consistent with certain disclosed embodiments of the present invention.

Referring to FIG. 6, an image extraction module, such as camera 610, captures at least a video source to obtain an original image 110a. The format of the image may be YUV, RGC, YCbCr, NTSC, PAL, and so on. Image information annotation module 120 embeds annotation information (I₁, I₂, . . . , Iₙ), such as image feature information and external sensed signals, to object image 610a. At this point, the image contains annotation information (I₁, I₂, . . . , Iₙ), but the format of the image is still the same as original image 110a.

The image with annotation information is compressed by image compression module 130 as Motion JPEG or Mpeg-4 format, and transmitted through network. After receiving the image of the Motion JPEG or Mpeg-4 format, the back-end of the video surveillance system utilizes image decompression module 140 to recover the image to original image 110a format, such as YUV, RGC, YCbCr, NTSC, PAL, and so on.

After the compression and decompression process, the annotated image is partially distorted. Image information de-annotation module 150 utilizes an error recovery decoding technique matching the system front-end to separate an object image 150a from annotation information, obtains de-annotation information (I_{1′}, I_{2′}, . . . , I_{n′}), and ensures to fully recover to annotation information (I₁, I₂, . . . , Iₙ); i.e., I₁=I_{1′}, I₂=I_{2′}, . . . , Iₙ=I_{n′}.

Therefore, according to the video surveillance system of the present invention, the image may be annotated with image feature information and external sensed signals, and the annotation information may be fully recovered. Because the format of the image is not changed, the annotation information is not affected by subsequent compression and transmission. Therefore the video surveillance system of the present invention may combine with the current image processing technique and compatible with the current surveillance system. The system back-end may fast recover the annotated original image to provide fast image search for key event and improve the security surveillance efficiency.

Although the present invention has been described with reference to the exemplary disclosed embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An video surveillance system, comprising:
an image extraction module for capturing at least a video source to obtain an original image and capturing feature information of said original image;
an image annotation module for embedding annotation information including at least said feature information into said original image, and converting said embedded image into a second image of the same format as said original image;
an image compression module for compressing said second image;
an image decompression module for decompressing said compressed second image; and
an image information de-annotation module for extracting embedded information from said decompressed second image and separating an object image from said annotation information to obtain de-annotation information.

2. The system as claimed in claim 1, wherein said annotation information is chosen from a group of environmental parameter information and feature information of said original image.

3. The system as claimed in claim 2, wherein said environmental parameter information is the information of a plurality of external sensed signals.

4. The system as claimed in claim 1, wherein said image information annotation module encodes said annotation information and embeds into said original image through an encoding technique.

5. The system as claimed in claim 1, wherein said encoding technique is an error recovery encoding technique.

6. The system as claimed in claim 1, wherein said de-annotation information is a fully recovery of said annotation information.

7. The system as claimed in claim 1, wherein said image information de-annotation module obtains said de-annotation information through an error recovery decoding technique.

8. The system as claimed in claim 1, wherein the data amount of said feature information is far less than the data amount of said original image.

9. The system as claimed in claim 1, wherein said image information annotation module further includes:
an error recovery processing unit for encoding said annotation information into embedded information;
an image processing unit for computing an embeddable information capacity of said original image through processing said original image; and
an annotation unit for embedding L copies of said embedded information into said original image, L is an embedded information multiple, and converting said embedded image into said second image.

10. The system as claimed in claim 9, wherein said embeddable information capacity is an information capacity to ensure the integrity of said embedded information when embedded.

11. The system as claimed in claim 9, wherein said embedded information multiple L depends on said embeddable information capacity, length of said embedded information and a compression ratio.

12. An image information annotation module, comprising:
an error recovery processing unit for encoding annotation information including at least feature information of an original image into embedded information;
an image processing unit for computing an embeddable information capacity of said original image; and
an annotation unit for embedding L copies of said embedded information into said original image, L is an embedded information multiple, and converting said embedded image into a second image.

13. The module as claimed in claim 12, wherein said embedded information multiple L depends on said embeddable information capacity, length of said embedded information and a compression ratio.

14. The module as claimed in claim 12, wherein data amount of said L copies of said embedded information is less than said embeddable information capacity.

15. An image de-annotation module, comprising:
a de-annotation unit for extracting an embedded information from an embedded stream and obtaining de-annotation information via error recovery processing, said de-annotation information being a fully recovery of annotation information; and
an image processing unit for separating said de-annotation information from an object image through image processing.

16. An image information annotation method, comprising:
embedding annotation information including at least feature information of an original image into said original image; and
converting said embedded image into a second image of the same format as said original image.

17. The method as claimed in claim 16, wherein said feature information of said original image is combined with environmental parameter information to form said annotation information and then said annotation information is encoded as embedded information.

18. The method as claimed in claim 16, said method encodes said annotation information as embedded information through an error recovery encoding technique and a threshold scheme.

19. The method as claimed in claim 17, wherein L copies of said embedded information are embedded into said original image, where L is an embedded information multiple and depends on an embeddable information capacity, length of said embedded information and a compression ratio.

20. An image de-annotation method, comprising:
extracting embedded information from an embedded stream;
obtaining de-annotation information from said extracted embedded information, said de-annotation information being a full recovery of annotation information; and
separating an object image from said de-annotation information through image processing.

21. The method as claimed in claim 20, wherein said de-annotation information includes at least feature information of said object image.

22. The method as claimed in claim 21, wherein said de-annotation information further includes environmental parameter information.

23. The method as claimed in claim 22, wherein said environmental parameter information is a plurality of external sensed signals.
